(19) United States
(12) Patent Application Publication
(10) Pub. No.: US 2012/0112124 A1
(43) Pub. Date: May 10, 2012

(54) ALUMINUM ETCHANT

(75) Inventors: Chun-Han Wu, Longtan Township (TW); Tien-Huat Gan, Taipei City (TW)

(73) Assignee: SECURITAG ASSEMBLY GROUP CO., LTD., Dali City (TW)

(21) Appl. No.: 12/942,974

(22) Filed: Nov. 9, 2010

(51) Int. Cl. C09K 13/04

(52) U.S. Cl. 252/79.2

(57) ABSTRACT

An aluminum etchant includes 3-30 wt % of hydrochloric acid, 4-20 wt % of sulfuric acid, and water for the rest. The etchant can produce circuits of 200-25 μm wide on an aluminum foil or aluminum plate. The circuit has good quality. Therefore, the invention is suitable for miniaturized products that require higher precision.

### BACKGROUND OF THE INVENTION

1. Field of Invention

The invention relates to an aluminum etchant and, in particular, to an etchant for aluminum foils or plates to render thin wires with high precision.

2. Related Art

Generally speaking, there are many ways to make RFID antennas. One method is etching. The required circuit pattern is produced by etching a copper foil or aluminum foil attached on a substrate such as PET or PI.

Currently, RFID manufacturers include Novatron, Savcor, and Shanghai Inlay Their respective products are shown in FIGS. 3A and 3B, FIGS. 4A and 4B, and FIGS. 5A and 5B. Both sides of the wire in their products apparently are irregular and even rough. According to the scale in the figures, the wire width is about a few hundred μm, which is not suitable for compact devices.

FIGS. 6A and 6B show the results of using hydrochloric acid as the etchant. The wires are obviously rough and wide. FIGS. 7A and 7B and FIGS. 8A and 8B show the results of using copper chloride and sulfuric acid as the etchants, respectively. In generally, even though using these etchants for etching can produce thinner wires, sometimes there are still some breaks, as shown in FIGS. 6A and 7A. Or there is the problem of huge variation in width or high roughness, which is more apparent in FIGS. 6B and 7B. When the wire is too narrow, it may break and affects the signal quality. If the wire is too wide, then it is likely to touch adjacent circuits, also affecting the signal quality. Therefore, even if it is possible to etch thin wires, the quality is not good enough to avoid breaking or open circuits. It is still difficult to apply the existing techniques to most products.

Besides, aluminum etching is usually done by printing. The printing techniques include screen printing, intaglio printing, and flexographic printing. An anti-etching layer formed by photoresist ink directly prints a pattern on the surface of an aluminum foil. The thickness of the printing layer can be 5-25 μm. However, various printing processes have different effects on the printed pattern profile due to different printing qualities. Therefore, there may be such problems as breaking, open circuit, wire width stability, and edge roughness. After the printing is finished, places not covered by the anti-etching layer are processed using chemical wet etching. The etching chemical agent then continuously diffuses and reacts with aluminum.

In addition to printing, one can also make use of the optical lithography to define the pattern. This technique covers the anti-etching layer on an aluminum foil by coating a wet film or attaching a dry film, followed by the image transfer through exposure. This image transfer can render better graphic resolution and quality than printing. After the exposure defines the pattern, unprotected parts are removed by development. The developer can be Na₂CO₃, NaOH or K₂CO₃ 0.2-5.0%. The chemical wet etching procedure follows the removal, and the stripping procedure goes afterwards. The production is finished after the anti-etching layer is removed.

Currently, there are many obstacles in aluminum etching. It is extremely difficult to achieve the same quality and specification as copper wires. Although good quality can be obtained using dry gas etching in semiconductor manufacturing processes, the procedure and equipment are very expensive. Moreover, line widths in the range of 200-25 μm cannot be achieved through other methods.

Since aluminum is an amphoteric element in group 3A, it reacts in both acidic and alkaline conditions. It can be easily oxidized because of a low oxidation potential. The produced aluminum oxide is chemically stable for protecting aluminum. Nonetheless, this causes a difficulty in etching aluminum. Under a strong acidic or alkaline condition, the oxide on the surface of aluminum will have holes. The inner aluminum metal reacts only after the protecting oxide is completely removed. This is the reason why one often obtains saw-like edges in aluminum etching. The etching effect is usually bad when the line width is smaller than 200 μm, so that the aluminum line edge is often irregular, thus affecting the circuit quality. Adding an active agent, on the other hand, usually produce black edges or abnormal shapes. When using hydrochloric acid as the base to make various kinds of etchants, there is the problem of sticky photoresist ink as the pH value gets too low, reducing circuit quality. Using etchants based on NaOH, one often encounters over-etching or floating films. These are the problems commonly seen in aluminum etching.

In the trend of compactifying modern electronics, the above-mentioned etching method for manufacturing RFID antennas has encountered some problems. That is, for smaller and high precision antenna designs, the current etching techniques are insufficient. It is therefore highly desirable to improve the method in order to make even smaller RFID antennas.

### SUMMARY OF THE INVENTION

An objective of the invention is to solve the above-mentioned problems by providing an aluminum etchant, in order to perform high precision (200-25 μm line width) etching on aluminum. The circuit thus obtained has better quality. Using the invention, the RFID antenna can have a smaller size that is suitable for compact devices.

To achieve the above-mentioned objective, the disclosed etchant includes 3-20 wt % of hydrochloric acid, 4-20 wt % of sulfuric acid, and water for the rest.

Another composition of the disclosed etchant is 3-20 wt % of hydrochloric acid, 10-50 wt % of phosphoric acid, and water for the rest.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1A is a photo of using the disclosed etchant in one composition to etch aluminum;

FIG. 1B is a magnified view of FIG. 1A;

FIG. 2A is a photo of using the disclosed etchant in another composition to etch aluminum;

FIG. 2B is a magnified view of FIG. 2A;

FIG. 3A is a view of a Novatron's RFID product under a microscope;

FIG. 3B is another view of a Novatron's RFID product under a microscope;

FIG. 4A is a view of a Savcor's RFID product under a microscope;

FIG. 4B is another view of a Savcor's RFID product under a microscope;

FIG. 5A is a view of a Shanghai Inlay's RFID product under a microscope;

FIG. 5B is another view of a Shanghai Inlay's RFID product under a microscope;

FIG. 6A is a photo of using hydrochloric acid to etch aluminum in the prior art;

FIG. 6B is another photo of using hydrochloric acid to etch aluminum in the prior art;

FIG. 7A is a photo of using copper chloride to etch aluminum in the prior art;

FIG. 7B is another photo of using copper chloride to etch aluminum in the prior art;

FIG. 8A is a photo of using sulfuric acid to etch aluminum in the prior art; and

FIG. 8B is another photo of using sulfuric acid to etch aluminum in the prior art.

### DETAILED DESCRIPTION OF THE INVENTION

The present invention will be apparent from the following detailed description, which proceeds with reference to the accompanying drawings, wherein the same references relate to the same elements.

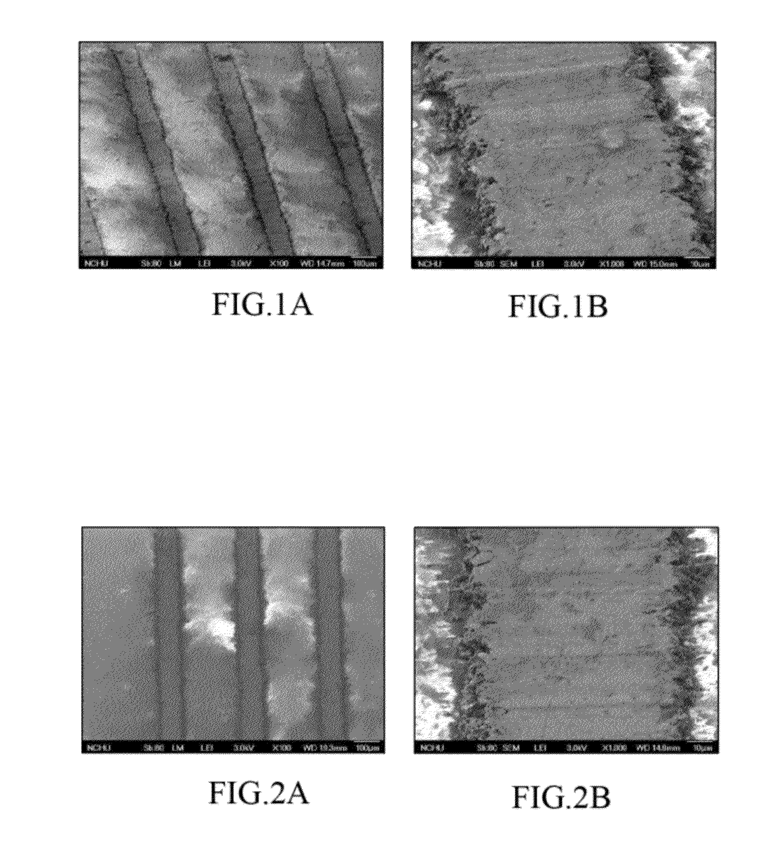

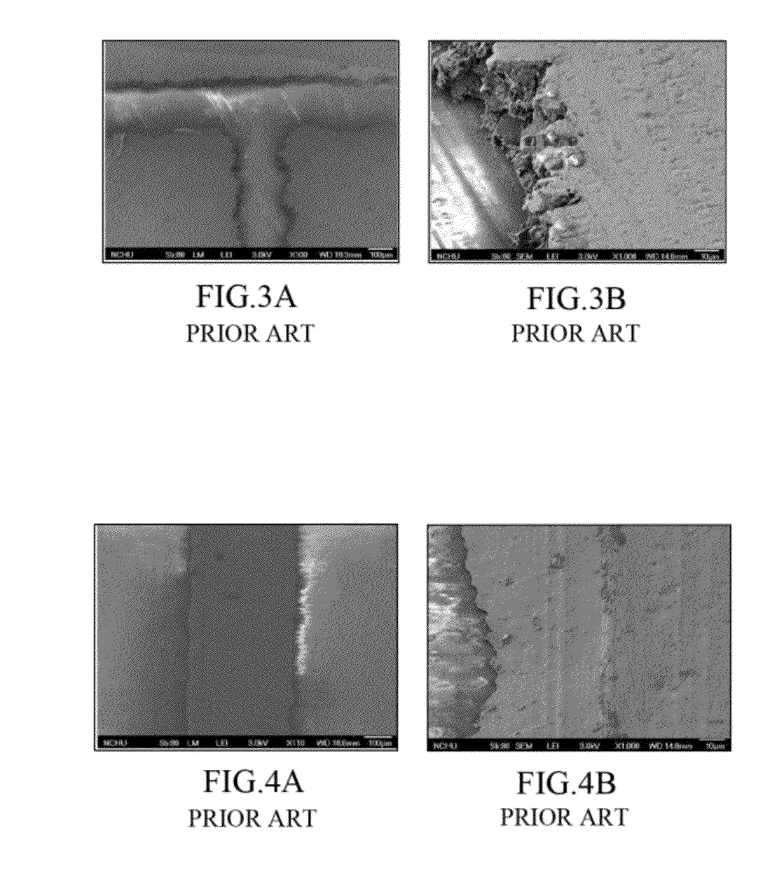

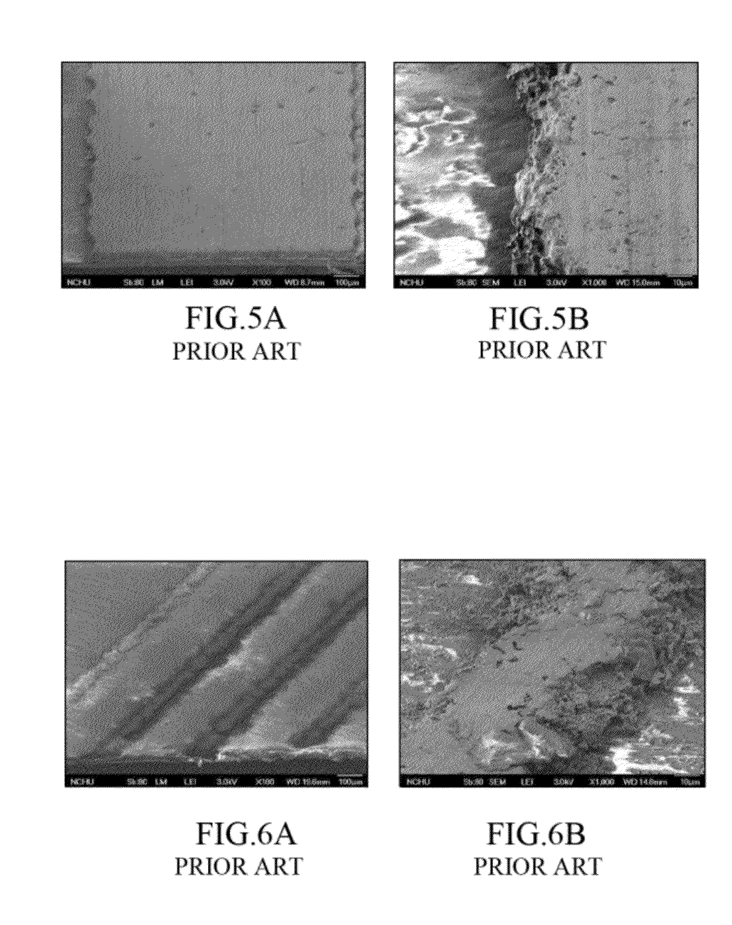

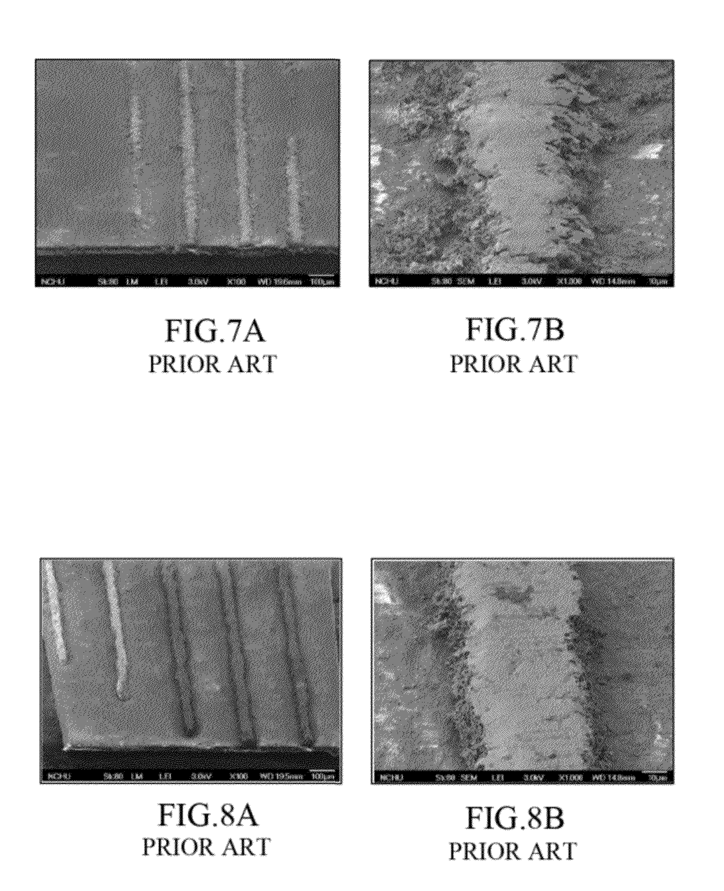

Please refer to FIGS. 1A to 2B for embodiments of the invention. The following paragraphs describe a first composition of the disclosed aluminum etchant. The etchant can be used to etch either aluminum foils or aluminum plates in order to produce required radio-frequency identification (RFID) antennas The etchant includes 3-20 wt % of hydrochloric acid (HCl), 4-20 wt % of sulfuric acid (H₂SO₄), and water for the rest, where wt % is the short-hand for weight percentage.

Besides, the invention adopts the printed circuit board (PCB) method (i.e., steps of photoresist coating, exposure, development, etching, and photoresist removal) to etch an RFID antenna circuit. In other words, a pattern for the RFID antenna is first defined on photoresist through exposure and development, followed by etching with the disclosed etchant. The following lists steps before and after etching according to the invention.

Photoresist Coating:

1. Use positive or negative, UV sensitive liquid photoresist designed particularly for the horizontal type roller coater. It is suitable for PCB etching, and has superior resolution and adhesion for preparing high precision PCB's.

2. Chemical composition: photosensitive acrylic resins.

3. Diluting agent: Propylene Glycol Methyl Ether Acetate (PMA).

4. Coating viscosity: 2,000±300 cps (25° C., B-type viscosity meter, probe no. 3).

5. Solid content: 39±2%.

6. Manufacturing conditions: speed 3.5 m/min.
(1) Upper pressure 1.2 kg/cm², lower pressure 1.0 kg/cm².
(2) Upper pressure 1.2 kg/cm², lower pressure 1.5 kg/cm².

Exposure:

1. High-pressure mercury lamp 5 KW/7 KW.

2. Parallel light source or random light source. Different optical energies affect the exposure time and pattern resolution.

Development:

1. Developer: Na2CO3/NaOH/K2CO3 0.2˜5.0%.

2. Temperature: 26˜50° C.

3. Pressure: 0.6˜2.5 Kg/cm².

4. Developing time: 25˜60 sec.

Etching:

Use hydrochloric acid and related oxidant, such as H₂SO₄, for etching. Utilizing properties of oxidants and controlling the proportion, one can still obtain good quality when the line width is 200˜25 μm. The etching rate (ER) can reach 10˜30 μm.

Photoresist Removal:

1. Remove photoresist ink after etching.

2. Stripping solution: NaOH 1˜6%.

3. Temperature 35˜50° C.

4. Stripping time 20˜60 sec.

Furthermore, based on the above-mentioned process, experiments are done using three different sets of numbers, as given in Table 1.

TABLE 1

| No. | HCl/H₂SO₄ (wt %) |
|---|---|
| 1 | 6/19.2 |
| 2 | 12/12.5 |
| 3 | 20/5.5 |

Water for the rest to make up 100 wt %

Using these proportions, one can generally obtain lines shown in FIGS. 1A and 1B, where the line width is about a few tens of μm. It is observed that both sides of the lines are smoother. The variation in line width is not large. And there is no break in the lines.

A second composition of the disclosed etchant is 3-20 wt % of HCl, 10-50 wt % of phosphoric acid (H₃PO₄), and water for the rest.

As shown in Table 2, four different sets of numbers are used in experiments.

TABLE 2

| No. | HCl/H₃PO₄ (wt %) |
|---|---|
| 1 | 4/49 |
| 2 | 11/40 |
| 3 | 18.7/32 |
| 4 | 15.1/45 |

Water for the rest to make up 100 wt %

Likewise, as shown in FIGS. 2A and 2B, good lines of width a few tens of μm can be obtained from the etching. Again, both sides of the lines are smoother. The variation in line width is not large. And there is no break in the lines.

Moreover, the above-mentioned phosphoric acid (H₃PO₄) occupies about 20-50 wt %. Besides, the etchant includes 5-20 wt % of nitric acid (HNO₃).

Four different sets of numbers are used in experiments, as shown in Table 3.

TABLE 3

| No. | HCl/H₃PO₄/HNO₃ (wt %) |
|---|---|
| 1 | 3.5/50/9.3 |
| 2 | 10/32/5.3 |
| 3 | 12/40/13.8 |
| 4 | 20/20/19.3 |

Water for the rest to make up 100 wt %

The composition of this etchant is slightly different from the above-mentioned ones. It includes HNO₃. The experiments show that lines similar to those in FIGS. 2A and 2B are obtained here too.

In summary, the new etchant disclosed herein can produce smaller line widths (200-25 μm) on aluminum foils or aluminum plates. Moreover, the line quality thus obtained is much better than the prior art. There is no break or over-roughness. The width of line is generally uniform. Therefore, the disclosed etchant can be used to manufacture smaller, high precision RFID antennas for compact electronic devices.

The above-mentioned method of making aluminum circuit patterns can be applied to coiling soft circuits, electrodes, or other aluminum conductors. Utilizing the metal properties of aluminum, the aluminum foil can be attached to various soft substrates, such as PET and PI. Taking the aluminum foil as an example, its thickness ranges from 7 μm to 100 μm. The substrate thickness can go from 18 μm to 125 μm. The manufacturing process includes the roll-to-roll process, and uses the lithography or printing technique to define the required pattern.

Although the invention has been described with reference to specific embodiments, this description is not meant to be construed in a limiting sense. Various modifications of the disclosed embodiments, as well as alternative embodiments, will be apparent to people skilled in the art. Therefore, it is contemplated that the appended claims will cover all modifications that fall within the true scope of the invention.

What is claimed is:

1. An aluminum etchant comprising 3-20 wt % of hydrochloric acid, 4-20 wt % of sulfuric acid, and water for the rest.

2. An aluminum etchant comprising 3-20 wt % of hydrochloric acid, 10-50 wt % of phosphoric acid, and water for the rest.

3. The aluminum etchant of claim 2 comprising 20-50 wt % of phosphoric acid and 5-20 wt % of nitric acid.
